(19) United States
(12) Patent Application Publication
(10) Pub. No.: US 2004/0211815 A1
(43) Pub. Date: Oct. 28, 2004

(54) Apparatus for removing an image sensor from a printed circuit board

(76) Inventors: Jackson Hsieh, Hsinchu Hsien (TW); Ying-Hao Hung, Hsinchu Hsien (TW); Yien-Su Huang, Hsinchu Hsien (TW)

Correspondence Address: PRO-TECHTOR INTERNATIONAL, 20775 Norada Court, Saratoga, CA, 95070-3018, US

(21) Appl. No.: 10/422,196

(22) Filed: Apr. 23, 2003

(51) Int. Cl. B23K 1/018

(52) U.S. Cl. 228/20.1; 228/264

(57) ABSTRACT

An apparatus for removing an image sensor from a printed circuit board. The apparatus includes a hot-air nozzle for producing hot air and a hot-air tube connected to the hot-air nozzle to transfer the hot air produced by the hot-air nozzle. The hot-air tube surrounds the image sensor and is formed with a plurality of outlets for outputting the hot air toward the image sensor so as to melt the solder.

### BACKGROUND OF THE INVENTION

1. Field of the Invention

The invention relates to an apparatus for removing an image sensor from a printed circuit board, and more particularly to an apparatus for effectively removing an image sensor from a printed circuit board in order to facilitate the changing of welding positions or replacement of the image sensor.

2. Description of the Related Art

A general sensor is used to sense signals, which may be optical or audio signals. The sensor of the invention is used to receive image signals or optical signals. After receiving the image signals, the sensor converts the image signals into electrical signals, which are then transmitted to a printed circuit board via a substrate.

Referring to FIG. 1, a conventional image sensor includes a substrate 10, a frame layer 12, a photosensitive chip 14, a plurality of wires 15, and a transparent layer 22. The substrate 10 has an upper surface 11 on which signal input terminals 18 are formed, and a lower surface 13 on which signal output terminals 24 are formed. The frame layer 12 is arranged on the substrate 10 to form a cavity 16 together with the substrate 10. The photosensitive chip 14 is arranged on the substrate 10 and within the cavity 16. A plurality of bonding pads 20 is formed on the photosensitive chip 14. The wires 15 electrically connect the bonding pads 20 of the photosensitive chip 14 to the signal input terminals 18 of the substrate 10, respectively. The transparent layer 22 is coated with an adhesive layer 23 and arranged on the frame layer 12 to cover and encapsulate the photosensitive chip 14.

When the image sensor is used, it is welded to a printed circuit board 28 by solder 26 so that the image signals from the image sensor may be transferred to the printed circuit board 28. During the welding process, however, if the image sensor is not welded to a proper position on the printed circuit board 28 or the welded image sensor fails to work, the overall printed circuit board 28 and image sensor have to be treated as waste material. Therefore, the manufacturing cost is high and the resources are wasted.

### SUMMARY OF THE INVENTION

An object of the invention is to provide an apparatus for removing an image sensor from a printed circuit board, and the apparatus may advantageously melt solder to facilitate the removing of the image sensor.

To achieve the above-mentioned object, the invention provides an apparatus for removing an image sensor from a printed circuit board. The apparatus includes a hot-air nozzle for producing hot air and a hot-air tube connected to the hot-air nozzle to transfer the hot air produced by the hot-air nozzle. The hot-air tube surrounds the image sensor and is formed with a plurality of outlets for outputting the hot air toward the image sensor so as to melt the solder.

### BRIEF DESCRIPTION OF THE DRAWINGS

FIG. 1 is a schematic illustration showing a conventional image sensor.

FIG. 2 is a pictorial view showing an apparatus for removing an image sensor of the invention.

FIG. 3 is a top view showing the apparatus for removing the image sensor of the invention.

FIG. 4 is a side view showing the apparatus for removing the image sensor of the invention.

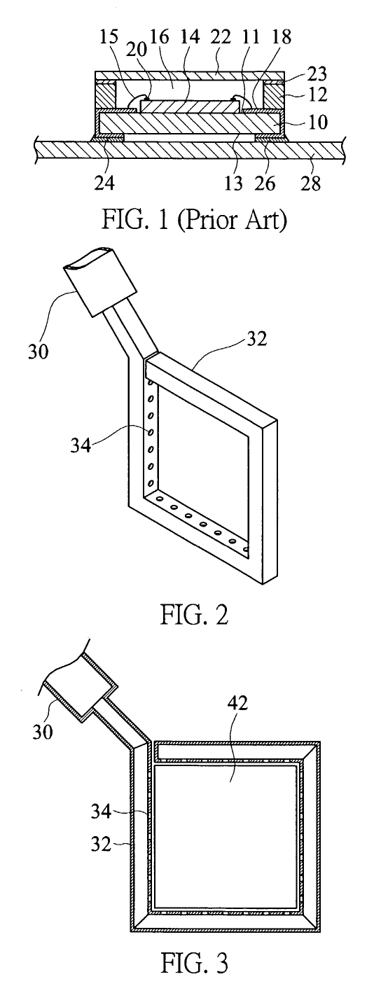

### DETAILED DESCRIPTION OF THE INVENTION

Referring to FIG. 2, an apparatus for removing an image sensor from a printed circuit board of the invention includes a hot-air nozzle 30 and a hot-air tube 32.

The hot-air nozzle 30 produces hot air having a proper temperature, which may range from 170 to 190° C., in order to melt solder.

The hot-air tube 32 is connected to the hot-air nozzle 30 for transferring the hot air produced by the hot-air nozzle 30. The hot-air tube 32 may have a rectangular cross section and may be shaped into a rectangular region to surround the image sensor that is to be removed. The hot-air tube is formed with a plurality of outlets 34 at a side facing the image sensor. Thus, the hot air may be output from the outlets 34 to the image sensor so as to melt the solder.

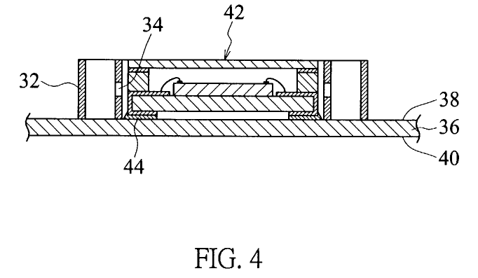

Please refer to FIGS. 3 and 4. A printed circuit board 36 has a first surface 38 and a second surface 40. An image sensor 42 is welded to the first surface 38 of the printed circuit board 36 by solder 44. When the image sensor 42 is to be removed from the printed circuit board 36, the hot-air tube 32 may first surround the image sensor 42, and the hot air is transferred from the outlets 34 of the hot-air tube 32 to the image sensor 42. Then, the solder 44 is melted when the temperature thereof rises to a proper one. Next, the image sensor 42 may be easily removed from the printed circuit board 36. Since the hot air is transferred to four sides of the image sensor 42, the solder 44 may be uniformly melted, and the image sensor 42 may be easily removed from the printed circuit board 36.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. An apparatus for removing an image sensor from a printed circuit board, which has a first surface and a second surface, the image sensor being welded to the first surface by solder, and the apparatus comprising:
a hot-air nozzle for producing hot air; and
a hot-air tube connected to the hot-air nozzle to transfer the hot air produced by the hot-air nozzle, wherein the hot-air tube surrounds the image sensor and is formed with a plurality of outlets for outputting the hot air toward the image sensor so as to melt the solder.

2. The apparatus according to claim 1, wherein the hot-air tube has a rectangular cross section.

3. The apparatus according to claim 1, wherein the temperature of the hot air ranges from 170 to 190° C.
